(19) United States
(12) Patent Application Publication
(10) Pub. No.: US 2022/0316381 A1
(43) Pub. Date: Oct. 6, 2022

(54) PHOTOCATALYTIC CAPSULE TO BE USED IN THE IMPROVEMENT OF FUEL PROPERTIES

(71) Applicant: ONDOKUZ MAYIS UNIVERSITESI, Samsun (TR)

(72) Inventors: Murat KAPUSUZ, Samsun (TR); Hakan OZCAN, Samsun (TR); Mevlut GURBUZ, Samsun (TR)

(73) Assignee: ONDOKUZ MAYIS UNIVERSITESI, Samsun (TR)

(21) Appl. No.: 17/642,692

(22) PCT Filed: Jul. 28, 2020
(86) PCT No.: PCT/TR2020/050667

§ 371 Date: Mar. 13, 2022

(30) Foreign Application Priority Data
Sep. 19, 2019 (TR) 2019/14269

(51) Int. Cl. F01N 3/20; F01N 3/28

(52) U.S. Cl. CPC F01N 3/2086; F01N 3/2896; F01N 2370/02; F01N 2510/06

(57) ABSTRACT

The present invention relates to the photocatalysis unit (100) that reduces the exhaust emission while enriching the combustion properties of gasoline and other alternative fuels used in the internal combustion engines by means of photocatalysis and TiO2 The photocatalysis unit (100) is developed to more easily control the exhaust emissions by way of changing the fuel properties prior to combustion in the internal combustion engines and to increase the fuel combustion efficiency. Combustion is improved by means of the photocatalytic effect posed by said photocatalysis unit (100), thereby both reducing the fuel consumption and reducing the hydrocarbon and carbon monoxide emissions resulting from the incomplete combustion, depending on the improvement of the combustion.

### Technical Field

The present invention relates to a photocatalysis unit that reduces the exhaust emission while enriching the combustion properties of gasoline and other alternative fuels used in the internal combustion engines by means of photocatalysis and TiO₂.

In particular, the present invention relates to a photocatalysis unit that is employed by integrating to the fuel supply system in the internal combustion engines, improves the fuel combustion performance, and thus reduces the fuel comsumption, while decreasing hydrocarbon and carbon monoxide emission resulting from incomplete combustion.

### State of the Art

Internal combustion engines are machines that drive the component called piston by means of the pressure occurring the combustion of fuel in a restricted area called the combustion chamber in the engine. The reason those engines are called internal combustion engines is that the combustion process occurs in the engine. 67% of the energy obtained through the fuel combusted in said combustion chamber disappears in the engine. A certain portion of the disappeared energy is discharged through the exhaust system and another portion thereof is discharged through the cooling system to atmosphere. 10% of the available energy disappears on the friction components such as shaft, axle, and wheels. When considering the following factors (steering wheel, brake, air conditioner, wiring, and the like), it means that just 13% of the energy is used to drive the vehicle and keep it driven. Said energy disappears because of the flexibility of wheels and more commonly the friction force caused by the air referred to as the wind resistance.

Nowadays, studies performed on the internal combustion engines focus on obtaining the maximum power from the engine economically without causing any pollution for the environment. Researches are mainly based on increasing the effective efficiency, minimizing the power losses, and reducing the exhaust emissions of the engine under all kind of operation conditions. The improvement of the performance and the exhaust emissions depends on that the combustion process is carried out effectively in a short time. Adaptation of multiple parameters for keeping the combustion efficiency at the maximum levels under all kinds of operation conditions according to operation conditions of the engine will yield in the conversion of the fuel into energy in the most efficient manner. To this end, some operation parameters such as ignition advance, on/off duration of the valve, compression ratio, and air/fuel ratio are varied according to the engine speed and load.

Nowadays, many studies have been conducted relating to the fuel-saving in the internal combustion engines and increasing the engine performance and as a result of the studies, fuel additives are developed by means of the new embodiments. However, most of those studies do not provide any advantage relating to the reduction of the emission values. It is considered generally the post-in-cylinder combustion for the exhaust emission controls and it is tried to change the values after the emission occurrence. Said applications make it more troublesome to control it. One of the studies conducted on eliminating the exhaust emission discharge is the invention subjected to the patent US5778664. The invention relates to a method and apparatus for the destruction of emissions from an internal combustion engine wherein a substrate coated with TiO2 is exposed to a light source in the exhaust system of an internal combustion engine thereby catalyzing oxidation/reduction reactions between gaseous hydrocarbons, carbon monoxide, nitrogen oxides and oxygen in the exhaust of the internal combustion engine. In said invention, it is used sensitizers such as phenylfluorone, squaraines, anthracene-9-carboxylic acids, and semiconductors such as TiO₂, SnO₂, ZnO, while applying photocatalysts to the exhaust smoke. Another study is the invention subjected to the patent US6153159. The invention relates thermal catalysts, particularly catalysts coated with precious metals, which are used to reduce the concentration of CO, HC, and NOx in exhaust gases from internal-combustion engines. While catalysts coated with precious metals exhibit catalytic activity for about 140° C., to ensure very low emission levels thermal catalysts need to be heated during cold starting so that the pollutants produced during the cold start react. The specification discloses a catalyst with a photocatalytic semiconductor illuminated with UV light for this purpose. This enables pollutant levels to be reduced immediately after the engine has been started and even at relatively low ambient temperatures. Said method and developed apparatuses concentrate on the exhaust smoke in the first starting state of the engine, namely it is still cold and aims to reduce the emission values. The aforementioned invention is not sufficient to reduce the emission values, because they do not operate effectively due to carbon black smearing on the semi-conductor surface in the exhaust smoke heated together with the engine heating.

Another study conducted relating to providing the combustion efficiency in the internal combustion engines is the invention subjected to the patent W01999064739. The invention relates to a method for the optimization of commercial fuel combustion which, exploiting complex physical-chemical principles, considerably reduces its emissions. It consists in an appliance which intercepts the intake duct and by which a portion of the combustion air is conveyed into a vessel equipped on its inside walls with a photocatalyst, either solid or supported, bathed in a water solution with some salts (MgCl₂, CuCl₂, FeCl₃, KCI, KHCO₃, KNO₃, NH₄NO₃) diluted in it. The air conveyed in the vessel and the water solution is irradiated by a light source emitting in the interval of visible UV. This portion of air, after irradiation, is conveyed in the pipe leading to the combustion chamber where it is mixed with the remaining not-treated air. The invention integrated into the intake air line obtains aerosol by way of using salts with various chemical structures (MgCl₂, CuCl₂, FeCl₃, KCI, KHCO₃, KNO₃, NH₄NO₃) and applies simultaneously the photocatalysis method.

Another study is the invention subjected to the patent CN101545422. The invention relates to a photocatalyst layer placed into the casing body and an air activation device comprising an ultraviolet lamp for vehicles. The photocatalyst layers are net photocatalyst layers which are arranged in the outer shell in a layered way. The vehicle air activation device can be arranged in an air filter. The photocatalyst layer carries out the light-catalyzed reaction for air entering the photocatalyst layer under the irradiation of ultraviolet to generate a strong active group for activating air. After being mixed with fuel atomizing molecules, the air after photocatalysis is sent to an engine combustion chamber for combustion. The vehicle air activation device has low cost, small volume, lightweight, strong adaptability, and remarkable economic and social benefits. The invention integrated into the air filter outlet comprises a UV lamp that may be adjusted in accordance with the need.

That the present method performed for controlling the exhaust emissions of the internal combustion engines focus on mainly the post-in-cylinder combustion and the re-endeavor for the elimination after the emission occurrence makes it more troublesome to control it. Consequently, the need for a photocatalysis unit that eliminates the disadvantages in the prior art and decreases the exhaust emissions, while increasing the fuel properties and insufficiency of the existing solutions made the development in the respective field necessary.

In addition to all of these, all differences obtained in the tests performed without using reductant in the study are determined such that they are below experimental error factor, wherein it has become obvious that it is required to use the reductant so as overcome said problem. Therefore, in the patent application in the state of the art stated above and in the system without using any reductant in various studies, fuel economy efficiency is approximately 2.4%, wherein said value does not constitute any scientific meaning since it is below 3%, which is the approximate experimental error factor known from the literature.

### BRIEF DESCRIPTION OF THE INVENTION

The present invention relates to the photocatalysis unit that meets the above-mentioned requirements, overcomes all disadvantages, and provides some additional advantages and reduces the exhaust emission while enriching the combustion properties of gasoline and other alternative fuels used in the internal combustion engines.

Based on the state of the art, the objective of the invention is that it is much easier to control by means of changing the emission occurrence conditions even before the emission occurs, besides enriching the fuel properties through using photocatalysis and TiO₂ in the inventive photocatalysis unit.

The objective of the invention is to more easily control the exhaust emissions and to increase the fuel combustion performance due to the fact that the photocatalysis unit changes the physical and chemical properties of the fuel prior to the combustion.

Another objective of the invention is to reduce hydrocarbon and carbon monoxide emissions resulting from the incomplete combustion depending on improving both the fuel consumption and the combustion by means of the photocatalytic effect posed by the photocatalysis unit on the fuel.

Advantages of the invention are to ensure approximately 10% of fuel-saving by means of using ethanol as reductant, approximately 18.1% of reduction in CO emission, 7% of reduction in HC emission, 9.9% of reduction in specific fuel consumption as well as 9.1% of the increase in the effective efficiency and to expand the fuel storage lifespan.

Another objective of the invention is to prevent gasoline and UV-based deterioration by means of using polyimide plastic-material in the design of the photocatalysis unit.

Another objective of the invention is to reduce deteriorations due to the gasoline by means of using cyanoacrylate while coating the glass surface in the photocatalysis unit with TiO₂.

Another objective of the invention is to eliminate the heating effect of the UV lamp by means of the fan added to the box, to which the capsule in the photocatalysis unit is attached.

The structural and characteristic features of the invention as well as all advantages of it will be better understood in the detailed description provided by use and reference to the figures given below, and for that reason, the assessment should be made based on the said figures and detailed description.

### BRIEF DESCRIPTION OF THE FIGURES

In order for the embodiment of the invention and the advantages thereof together with additional components to be better understood, the below explained figures should be taken into account while making an evaluation.

FIG. 1 illustrates a general schematic view of the photocatalysis unit.

### REFERENCE NUMBERS

100. Photocatalysts unit

101. Air inlet

102. Fan

103. Fuel and reductant mixture inlet

104. UV lamp

105. Glass

106. Fuel and reductant mixture

107. TiO₂ coated surface

108. Photocatalytic capsule (Polyimide Plastic)

109. Air outlet

110. Fuel and reductant mixture outlet

111. Casing

### DETAILED DESCRIPTION OF THE INVENTION

In the detailed description, the inventive photocatalysis unit (100) that reduces the exhaust emission, while enriching the combustion properties of gasoline and other alternative fuels used in the internal combustion engines by means of photocatalysis and TiO₂ is disclosed such that it is exemplary for a better understanding of the subject and it does not constitute any limiting effect.

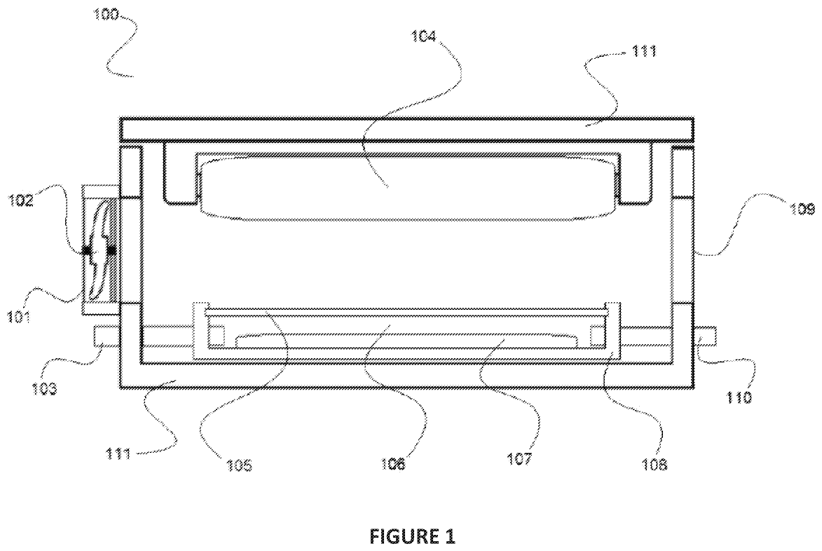

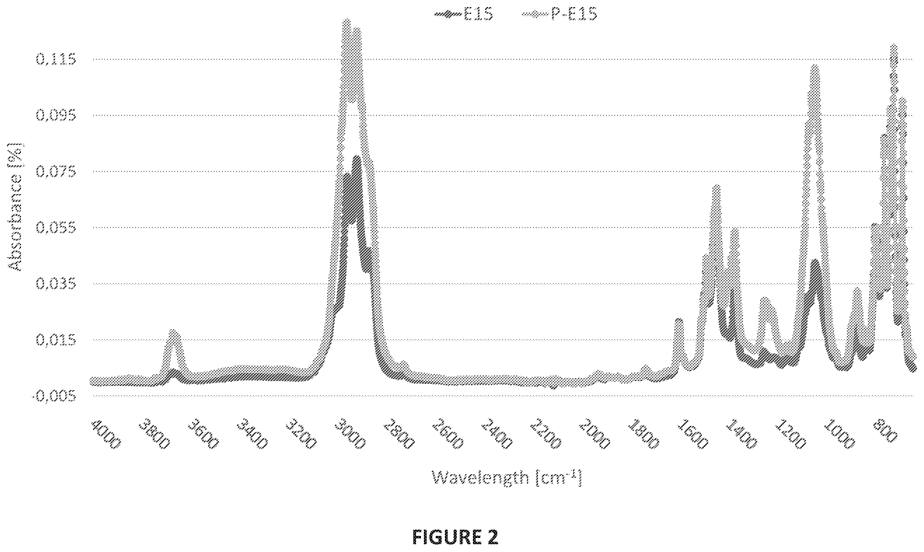

The photocatalysis unit (100) shown in FIG. 1 is developed to control the exhaust emissions more easily by way of changing the fuel properties prior to combustion in the internal combustion engines and to increase the fuel combustion performance.

Combustion is improved by means of the photocatalytic effect posed by said photocatalysis unit (100), thereby both reducing the fuel consumption and reducing the hydrocarbon and carbon monoxide emissions resulting from the incomplete combustion, depending on the improvement of the combustion. Said photocatalysis unit (100) basically comprises photocatalytic capsule (108) and UV lamps (104) positioned in the casing (111). The fan (102) to be used for cooling for the purpose of eliminating the heating effect of UV lamps (104) is positioned on any outer edges of the casing (111) in the monoblock or fragmental form and the air outlet (109), through which the air heated due to the UV lamps (104) is positioned on another outer edge of the casing and the air inlet (101), through which the air is the inlet. It comprises air inlet (101) and air outlet (109), such that they are at the opposite side of the casing (111). UV lamps (104) and photocatalytic capsule (108) are positioned oppositely on any one of the sides of the casing (111), preferably on the longer sides.

In the inventive photocatalysis unit (100), the photocatalytic capsule (108) is positioned in the photocatalysis unit (100) so as to both reduce the fuel consumption by way of improving the fuel combustion and to reduce the hydrocarbon and carbon monoxide emissions resulting from the incomplete combustion depending on the combustion improvement and comprises a TiO₂ coated surface (107) being a glass layer coated with TiO₂ at bottom of said photocatalytic capsule (108). A surface of the photocatalytic capsule (108) is made of glass (105) so that the light to come from the UV lamp (104) used to activate TiO₂ passes through or the glass (105) is mounted to said surface. Thus, at least one UV lamp (104) is positioned in the photocatalysis unit (100) and a photocatalytic capsule (108) comprising a glass (105) on the surface corresponding to the UV lamp (104) is positioned oppositely. Ethanol (C₂H₅OH) as a reductant together with the fuel is fed into the photocatalytic capsule (108) through the fuel and reductant mixture inlet (103) so as to subject the fuel in the photocatalytic capsule (108) positioned at a side of the photocatalysis unit (100) limited by the casing (111) to the photocatalytic effect. Fuel and reductant mixture inlet (106) is the element, through which the fuel and reductant mixture (106) is fed into the photocatalytic capsule (108), wherein its one end is connected with the fuel tank of the internal combustion engine and the other end designed such that it is open in the interior chamber of the photocatalytic capsule (108). Fuel and reductant mixture outlet (110) is the element, through which the fuel and reductant mixture is taken out of the photocatalytic capsule (108), wherein its one end is connected in the photocatalytic capsule (108) and its other end is connected at the outside of the casing (111) and its end is connected with the fuel line of the vehicle with the internal combustion engine. The photocatalysis unit may be also designed as the fuel tank.

Ethanol (C₂H₅OH) as a reductant in the volumetric ratio of 15% is mixed into the fuel to be fed into the photocatalytic capsule (108) and to be processed. Ethanol ratio may be 5% and above as long as it does not damage the engine operation and fuel system. After the fuel and reductant mixture (106) prepared is fed into the photocatalytic capsule (108), electrons of the TiO₂ coated surface (107) is stimulated, which is to exhibit a photocatalytic activity by means of UV light coming from the UV lamp (104) and passing through the glass (105) surface. Electrical conductivity occurs due to the fact that the electron on the valence band of the atom jumps up to the conductivity band of the atom. That the electrons jump up to the conductivity band from the valence band occurs by means of the UV lamp (104) stimulation. The TiO₂ coated surface comprising a particle size in the range of 10-100 nm and absolutely in the anatase form or comprising a sufficient level of rutile generates electron and hole pairs when subjected to the light coming from the UV lamp (104). The electron on the valence band of TiO₂ is stimulated and jumps up to the conductivity band when subjected to the light. Thus, it is generated (e−) loaded electron and (h+) loaded hole pairs. The generated hole pairs cause various conversions in hydrocarbons comprising oxygen. These conversions also trigger conversions among other hydrocarbons. In the studies conducted relating to the conversions, gasoline mixtures used as fuel are examined by means of FTIR (Fourier Transform Infrared Spectrometer) analysis before (E15 fuel) and after (P-E15 fuel) subjecting to the photocatalysis. FTIR results are shown in FIG. 2 and data of the conversions are shown in Table 1.

TABLE 1
Peak values and compound classes in the FTIR
spectrum for E15 and P-E15 fuels

| | | | Functional | Compound |
|---|---|---|---|---|
| WaveLength | E15 | P-E15 | Group | Class |
| 3700-3584 | 3675 | 3675 | O-H stretching | alcohol |
| 3000-2840 | 2963 | 2966 | C-H stretching | alkane |
| 3000-2840 | 2923 | 2923 | C-H stretching | alkane |
| 1420-1330 | 1378 | 1378 | O-H bending | alcohol |
| 1275-1200 | 1260 | 1259 | C-O stretching | Alkyl aryl ether |
| 1225-1200 | 1220 | 1220 | C-O stretching | vinyl ether |
| 1085-1050 | 1080 | 1075 | C-O stretching | Primary alcohol |
| 1060-1025 | 1051 | 1051 | C-O stretching | Primary alcohol |

FIG. 2 shows the effects of the photocatalysis on the molecular level and the chemical compound of the mixture. Peak values in the range of wavelength 3800-3660 cm⁻¹ prove that there is an increase in the alcohol content. The range is approximately plain for the gasoline and increases as the alcohol is introduced therein. Peak values increasing in the range of wavelength 3200-2800 cm⁻¹ shows that the amount of the large hydrocarbon molecule increases. In other words, it is seen that aliphatic carbon chains grow, and small molecules are unified into larger structures, Growth in the molecule structure causes an increase in the boiling point. Increases in the boiling point reduce the vapor pressure under the same conditions. While the dry vapor pressure equivalent (DUPE) of the pure gasoline is 62,7 kPa, it increases up to 67,8 kPa with an addition of 15% of the volumetric ethanol (reductant); it decreases to 64,7 kPa by subjecting to the photocatalysis. Values obtained through the vapor pressure proves the molecular growth. When examining the FTIR analysis, it is seen that there occurs a conversion into the ether groups in the gasoline, and thus the ether ratio increases.

As seen in Table 1 containing the results of FTIR analysis, peak points of 2963 cm⁻¹ and 2923 cm⁻¹ refer to the conversion into alkane and saturated hydrocarbons have more enhanced combustion. The reduction in fuel consumption in engine experiments proves this expression. The curve E15 in the range of the wavelength of 1300-1200 cm⁻¹ is almost plain and increases in this range prove the conversion into the ether groups as stated by Table 1. An increase in the ether ratio in the ether-gasoline mixture firstly reduces the specific fuel consumption [kg/kWh] and increases it after a certain ratio. Additionally, the increase in the ether ratio reduces CO and HC emissions. Increases in the range of wavelength of 1100-1000 cm⁻¹ show the increase in the density of the alcohol groups (primary alcohols). Reduction in the HC and CO emissions in engine tests proves this case. An increase in the alcohol ratio in the fuel content improves the combustion occurring in a limited period in the combustion chamber due to the higher flame speed of alcohol and reduces HC and CO emissions while increasing the combustion efficiency. The results also show that the oxidation stability of the test fuel E-15 increases by being subjected to the photocatalytic activity. An increase in the absorbance density peak points indicates the increase of fuel stability. In other words, the fuel can be stored for a longer time without losing its properties and forming a precipitate.

The fuel leaves the photocatalysis unit (100) through the fuel and reductant mixture outlet (110) by improving the combustion property of the fuel, such that both the fuel consumption is reduced and hydrocarbon and carbon monoxide emissions resulting from the incomplete combustion are reduced depending on the combustion improvement, after being subjected to the photocatalysis in the photocatalytic capsule (108).

The casing (111) in which the UV lamps (104) and photocatalytic capsule (108) are positioned is made of preferably wooden material (MDF—Medium Density Fiberboard). However, plastic derivatives thereof may be used also. The TiO₂ coated surface (107) is positioned in the photocatalytic capsule (108) integrated to said fuel feeding line and the transparent glass (105) is positioned on the surface corresponding to the UV lamps (104). Said gasoline and reductant mixture (106) passes through the photocatalytic capsule (108), namely between the TiO₂ coated surface (107) and the glass (105). The photocatalytic capsule (108) is designed in the form of a fuel passage area with a volume of 100 ml. It may be designed in the range of 50-1000 ml. It may be also designed as fuel tank. The TiO₂ coated surface is positioned in the enclosed volume (photocatalytic capsule—108) so that the fuel is subjected to the photocatalytic effect. Cyanoacrylate that does not easily react with the gasoline is used for the coating process, on the TiO₂ coated surface (107) obtained through coating a glass surface to be fitted into the photocatalytic capsule (108) with TiO₂. Anatase-rutile ratio in TiO₂ used on said TiO₂ coated surface (107) is 80:20 and the average particle size is 25 nm. However, TiO₂ may be comprised of complete anatase or may comprise rutile in various ratios, if necessary. The particle size may be any value in the range of 10 nm-100 nm. Reduction of the particle size will increase the activity, however, it will also increase the cost. At least one and preferably two UV lamp with the wavelength of 365 nm is positioned in the interior portion of the cover of the casing (111) so that the ultraviolet light is introduced into the gasoline and reductant mixture (106). The wavelength of the UV lamp may be in the range of 200 nm-700 nm. It is used as a cooling fan (102) to eliminate the heat resulting from the UV lamps (104) in said photocatalysis unit (100). The photocatalytic capsule (108) in the photocatalysis unit (100) is made of polyamide plastic-material, wherein the polyamide plastic-material is reduced to the desired size through the milling machine and is hollowed completely. On the front surface of the structure obtained, there are grooves, in which the glass (105) through which UV lights passes is to be positioned, and the transparent glass (105) is seated in those grooves, thereby achieving the photocatalytic capsule (108). The connection between the gasoline and reductant mixture inlet (103) and outlet (110) is provided by means of pipes made of preferably metal material and the outer edge surfaces of the glass (105) are isolated with silicone to provide proper sealing. Ethanol is used as a reductant in the gasoline and reductant mixture (106) in said photocatalysis unit (100). Ethanol is mixed more homogeneously with the gasoline based on the water use and helps with maintaining the contact since it does not smear on the TiO₂ coated surface (107). By using ethanol as reductant, as a result of the experiment carried out by photo-catalyzing the gasoline (E15) fuel containing ethanol in the volumetric ratio of %15 with the photocatalytic capsule (108) and the performance measured in the engine arrangement by obtaining 5L of fuel and the emission values, in case of use of the fuel (P-E15) obtained through subjecting the fuel E15 to the photocatalysis, it is achieved 18.1% of reduction in the CO emission, 7% of reduction in the HC emission, 9.9% of reduction in the specific fuel consumption and also 9.1% of the increase in the effective efficiency.

1. Photocatalysis unit (100) used in the fuel system of internal combustion engines, that both reduces fuel comsumption by improving the fuel combustion and reduces hydrocarbon and carbon monoxide emissions resulting from the incomplete combustion based on the combustion improvement, characterized by comprising; ethanol as a reductant in the ratio of 5% or more, that is used in the fuel to be subjected to the photocatalysis in the photocatalytic capsule (108) having a TiO₂ coated surface (107) by means of UV light provided by at least one UV lamp (104) positioned in the casing (111).

2. Photocatalysis unit (100) according to claim 1, characterized by comprising a UV lamp (104) in the wavelength range of 200-700 nm on the interior surface of any one of outer edges of the casing (111).

3. Photocatalysis unit (100) according to claim 1, characterized by comprising a cooling fan (102) positioned so as to eliminate the heat to be caused by the UV lamp (104) on any one of outer edges of the casing (111).

4. Photocatalysis unit (100) according to claim 1, characterized by comprising an air inlet (101) and air outlet (109), such that they are at the opposite side of the casing (111).

5. Photocatalysis unit (100) according to claim 1, characterized in that the surface of its photocatalytic capsule (108), that corresponds to the UV lamp (104), is of glass (105).

6. Photocatalysis unit (100) according to claim 1, characterized in that its photocatalytic capsule (108) comprises a fuel and reductant mixture inlet (103), in which the fuel and reductant mixture (106) is fed.

7. Photocatalysis unit (100) according to claim 1, characterized in that the fuel and reductant mixture (106) fed into its photocatalytic capsule (108) comprises a fuel and reductant mixture outlet (110), through which it is discharged, after being subjected to the photocatalysis.

8. Photocatalysis unit (100) according to claim 1, characterized in that its photocatalytic capsule (108) comprises a TiO₂ coated surface (107), which has a particle size in the range of 10-100 nm and is of the entire anatase form or comprises rutile in sufficient amounts.
